(19) United States
(12) Patent Application Publication
(10) Pub. No.: US 2020/0385192 A1
(43) Pub. Date: Dec. 10, 2020

(54) RECYCLABLE INTERFERENCE-FIT BEVERAGE-INGREDIENT CARTRIDGE

(71) Applicant: PepsiCo, Inc., Purchase, NY (US)

(72) Inventors: Carlos Hernan MARINA, Key Biscayne, FL (US); Renee HAMAOUI, Boca Raton, FL (US); Carlos Enrique Magana ROMERO, Ciudad de Mexico (MX); Jose Arnaldo Cotto RODRIGUEZ, Aguas Buenas, PR (US); Michel ALVAREZ, Miami, FL (US)

(21) Appl. No.: 16/432,750

(22) Filed: Jun. 5, 2019

(51) Int. Cl. B65D 81/32; A47J 31/40

(52) U.S. Cl. CPC B65D 81/3205; A47J 31/407

(57) ABSTRACT

A beverage-ingredient cartridge for storing one or more beverage ingredients. A beverage-ingredient cartridge includes a first container for storing a first beverage ingredient and having a neck defining an opening at an upper end of the first container. The beverage-ingredient cartridge further includes a second container for storing a second beverage ingredient and having a body removably secured to the neck of the first container by an interference fit so as to cover and seal the opening of the first container, and a lid removably secured to the neck of the first container by an interference fit. The lid is positioned above and is in contact with the body such that the body and lid define an interior volume of the second container.

### FIELD

Embodiments described herein generally relate to beverage-ingredient-containing devices. Specifically, embodiments described herein relate to a beverage-ingredient cartridge that can selectively dispense stored beverage ingredients when a force is applied to the cartridge.

### BRIEF SUMMARY

Some embodiments are directed to a beverage-ingredient cartridge including a first container that includes a neck defining an opening at an upper end of the first container, and a second container. The second container includes a body removably secured within the neck of the first container by an interference fit so as to cover and seal the opening, and a lid removably secured within the neck of the first container, wherein the lid is positioned above and is in contact with the body such that the body and the lid define an interior volume of the second container. A skirt is secured to the first container and extends around the neck of the first container, and defines an opening through which the second container is accessible.

Some embodiments are directed to a method of dispensing a beverage from a beverage-ingredient cartridge that includes applying a force to a beverage-ingredient cartridge. The beverage-ingredient cartridge may include a first container having a neck at an upper end defining an opening, wherein the first container stores a first beverage ingredient, and a second container that stores a second beverage ingredient and that is secured within the neck of the first container and covers and seals the opening of the first container. The second container may include a body removably secured to the neck of the first container within the opening and a lid removably secured to the neck of the first container within the opening. The method may further include disengaging the lid and the body of the second container from the neck of the first container by the force, such that the body and the lid are directed into an interior volume of the first container, and dispensing the first and second beverage ingredients from the beverage-ingredient cartridge.

Some embodiments are directed to a beverage-ingredient cartridge that includes a first container defining an opening at an upper end of the first container, a second container removably secured to the upper end of the first container so as to cover and seal the opening of the first container, and a skirt secured to the first container such that the skirt covers the second container, and wherein the skirt defines an opening through which the second container is accessible.

Some embodiments are directed to a system for making a beverage that includes any of the beverage-ingredient cartridges described herein, a liquid beverage ingredient disposed within the first container, a dry beverage ingredient disposed within the second container, and a beverage vessel having a cartridge opener and containing a liquid. When the beverage-ingredient cartridge is engaged with the cartridge opener of the beverage vessel, the cartridge opener pushes the second container into the first container and thereby releases the liquid and dry beverage ingredients from the beverage-ingredient cartridge into the liquid under the force of gravity.

Some embodiments are directed to a beverage-ingredient cartridge that includes a first container having a neck defining an opening at an upper end of the first container, and a second container that includes a body removably secured within the neck of the first container by an interference fit so as to cover and seal the opening and a plastic film secured to an upper end of the body such that the body and the plastic film define an interior volume of the second container. A skirt may be secured to the first container, and the skirt extends around the neck of the first container and defines an opening through which the second container is accessible.

In any of the various embodiments discussed herein, the opening of the skirt may have a diameter that is less than a maximum diameter of each of the body and the lid of the second container such that the body and lid are unable to pass through the opening of the skirt.

In any of the various embodiments discussed herein, the skirt may further include a ridge on an interior surface of the skirt that is configured to engage a lip extending outwardly from a neck of the first container to secure the skirt to the first container. In some embodiments, the ridge of the skirt may be permanently secured to the lip of the neck of the first container.

In any of the various embodiments discussed herein, the beverage-ingredient cartridge may be made entirely of recyclable plastic. In some embodiments, the beverage-ingredient cartridge may include one or more of polypropylene (PP), polyethylene terephthalate (PET), and high density polyethylene (HDPE).

In any of the various embodiments discussed herein, the body and the lid of the second container may be configured to be disengaged from the neck of the first container in response to a force applied to the lid of the second container in a direction towards an interior volume of the cartridge. In response to application of the force on the lid, the lid may in turn exert a force on the body such that the body and lid are disengaged from the neck of the first container.

In any of the various embodiments discussed herein, the body of the second container may include a base having a perimeter with a flange extending perpendicularly from the perimeter of the base. In some embodiments, the lid of the second container may include a base having a perimeter with a flange extending perpendicularly from the perimeter of the base, and the flange of the body may meet in an end-to-end manner with the flange of the lid.

In any of the various embodiments discussed herein, the body of the second container may include a lip extending from a base of the body that is configured to prevent the body from passing through the opening of the first container to an exterior of the beverage-ingredient cartridge.

In any of the various embodiments discussed herein, a height of the second container as measured in a direction of a longitudinal axis of the cartridge may be the same as or less than a height of the neck of the first container as measured in a direction of the longitudinal axis of the cartridge.

In any of the various embodiments discussed herein, the neck of the first container may taper from an upper end of the first container toward a shoulder of the first container.

In any of the various embodiments discussed herein, the beverage-ingredient cartridge may be inverted prior to applying the force to the second container, such that dispensing the first and second beverage ingredients occurs under the force of gravity.

In any of the various embodiments discussed herein, a force may be applied to the second container of the beverage-ingredient cartridge by a cartridge opener applied along a longitudinal axis of the beverage-ingredient cartridge.

In any of the various embodiments discussed herein, the second container may be configured to be disengaged from the first container when a force is applied to the second container in a direction towards an interior volume of the cartridge, wherein when the second container is disengaged from the body, an interior volume of the first container and the second container are open to an exterior of the beverage-ingredient cartridge.

In any of the various embodiments discussed herein, the second container may include a body defining an upper opening and a lower opening, a first lid removably secured to the body so as to cover the lower opening, and a second lid removably secured to the body so as to cover the upper opening.

In any of the various embodiments discussed herein, the body of the second container may include a base having a flange extending from a perimeter of the base, such that the body has a cup-shape.

In any of the various embodiments discussed herein, the skirt may include a door that is movable between a first position in which the door covers the opening of the skirt, and a second position in which the door is rotated toward an interior volume of the cartridge, such that as the door moves from the first position to the second position, the door punctures the plastic film and applies a force to the body such that the body is dislodged from the neck of the first container.

In any of the various embodiments discussed herein having a plastic film, the plastic film may be secured to the upper end of the first container

### BRIEF DESCRIPTION OF THE FIGURES

The accompanying drawings, which are incorporated herein and form a part of the specification, illustrate the present disclosure and, together with the description, further serve to explain the principles thereof and to enable a person skilled in the pertinent art to make and use the same.

FIG. 1 shows a perspective view of a beverage-ingredient cartridge according to some embodiments.

FIG. 2 shows a longitudinal cross-sectional view of the beverage-ingredient cartridge of FIG. 1 as positioned for use with a beverage vessel.

FIG. 3 shows a longitudinal cross-sectional view of the beverage-ingredient cartridge of FIG. 1 in use to dispense beverage ingredients to the beverage vessel.

FIG. 4 shows an exploded view of the components of the beverage-ingredient cartridge of FIG. 1.

FIG. 5 shows a longitudinal cross-sectional view of the beverage-ingredient cartridge of FIG. 1.

FIG. 6 shows a longitudinal cross-sectional view of a first container of the beverage-ingredient cartridge of FIG. 1.

FIG. 7 shows an exploded longitudinal cross-sectional view of the components of a second container of the beverage-ingredient cartridge of FIG. 1.

FIG. 8 shows a longitudinal cross-sectional view of a skirt of the beverage-ingredient cartridge of FIG. 1.

FIG. 9 shows a perspective view of a lid of a second container of a beverage-ingredient cartridge according to some embodiments.

FIG. 10 shows a longitudinal cross-sectional view of a second container of a beverage-ingredient cartridge according to some embodiments in which a force is applied to disengage a lid of the second container.

FIG. 11 shows a perspective view of a beverage-ingredient cartridge according to some embodiments.

FIG. 12 shows a longitudinal cross-sectional view of the beverage-ingredient cartridge of FIG. 11 as positioned for use with a beverage vessel.

FIG. 13 shows a longitudinal cross-sectional view of the beverage-ingredient cartridge of FIG. 11 in use to dispense beverage ingredients to the beverage vessel.

FIG. 14 shows an exploded view of the components of the beverage-ingredient cartridge of FIG. 11.

FIG. 15 shows a longitudinal cross-sectional view of the beverage-ingredient cartridge of FIG. 11.

FIG. 16 shows a longitudinal cross-sectional view of a first container of the beverage-ingredient cartridge of FIG. 11.

FIG. 17 shows an exploded longitudinal cross-sectional view of the components of a second container of the beverage-ingredient cartridge of FIG. 11.

FIG. 18 shows a longitudinal cross-sectional view of a skirt of the beverage-ingredient cartridge of FIG. 11.

FIG. 19 shows a longitudinal cross-sectional view of the second container of FIG. 17 positioned within a neck of the first container of FIG. 16.

FIG. 20 shows a perspective view of a beverage-ingredient cartridge according to some embodiments.

FIG. 21 shows an exploded view of components of the beverage-ingredient cartridge of FIG. 20.

FIGS. 22A-22C show longitudinal cross-sectional views of the beverage-ingredient cartridge of FIG. 20 in different states to illustrate operation of the beverage-ingredient cartridge.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

Beverage-ingredient cartridges may contain one or more beverage ingredients for addition to water or another base liquid. A consumer can quickly and easily make a beverage by mixing the contents of the beverage-ingredient cartridge with water which is readily available to the user. Beverage-ingredient cartridges provide consumers with a convenient method for adding beverage ingredients to water or other base liquids rather than purchasing a pre-mixed beverage. Beverage-ingredient cartridges also provide a user with the experience of preparing and mixing their own beverage which some consumers may prefer to simply purchasing a pre-packaged beverage.

Some known beverage-ingredient cartridges include an aluminum foil seal covering an opening of the cartridge that can be punctured to release the beverage ingredient from the cartridge. However, the seal can be difficult to puncture properly. Difficulty puncturing the seal and dispensing the beverage ingredient from the cartridge may be frustrating and inconvenient for the consumer and may negatively impact the consumer's experience. If a consumer cannot readily open the beverage-ingredient cartridge and dispense the beverage ingredient, the consumer may be less likely to use the cartridge in the future or purchase additional beverage-ingredient cartridges. Even if the foil is punctured, it may still be difficult to fully evacuate a beverage ingredient from some cartridges, as the punctured foil may provide only a small path or opening through which a beverage ingredient may escape the cartridge. This may also be inconvenient for the consumer and may result in a waste of the beverage ingredients. Additionally, if the beverage ingredients in the cartridge are premeasured for use with a specific volume of base liquid, the resulting flavored beverage may not have the desired concentration and taste if the contents of the cartridge cannot be fully evacuated.

Some embodiments described herein relate to a beverage-ingredient cartridge for storing beverage ingredients that includes one or more components that can be disengaged upon application of a force to the beverage-ingredient cartridge so as to allow the beverage ingredients to be released from the cartridge. Further, some embodiments as described herein relate to a beverage-ingredient cartridge that is composed of recyclable plastic materials such that the beverage-ingredient cartridge is readily recyclable without separating and sorting components of the cartridge, which promotes easy recyclability, thereby raising recycling rates.

Some embodiments as described herein relate to a beverage-ingredient cartridge having a first container for storing a first beverage ingredient and a second container for storing a second beverage ingredient. The second container may include a body having an upper opening and a lower opening, and each opening is removably covered by a lid. The second container is positioned on an opening of the first container so as to cover the opening and seal the first container. When a force is applied to the lids of the second container, the lids are disengaged from the body and pushed into the first container, and the beverage ingredients in each of the first and second containers can escape the cartridge so that the beverage ingredients may be mixed with a liquid to create a beverage.

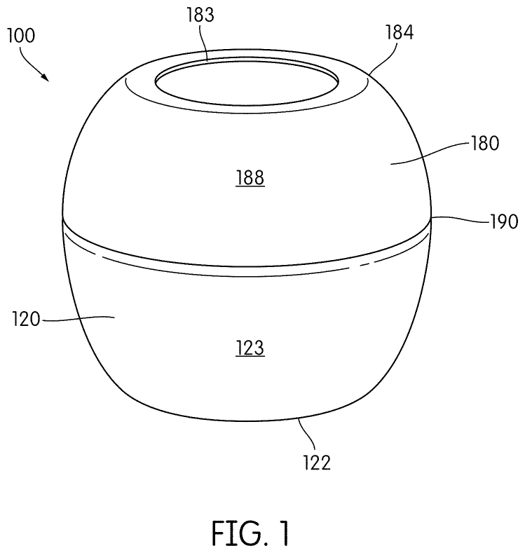

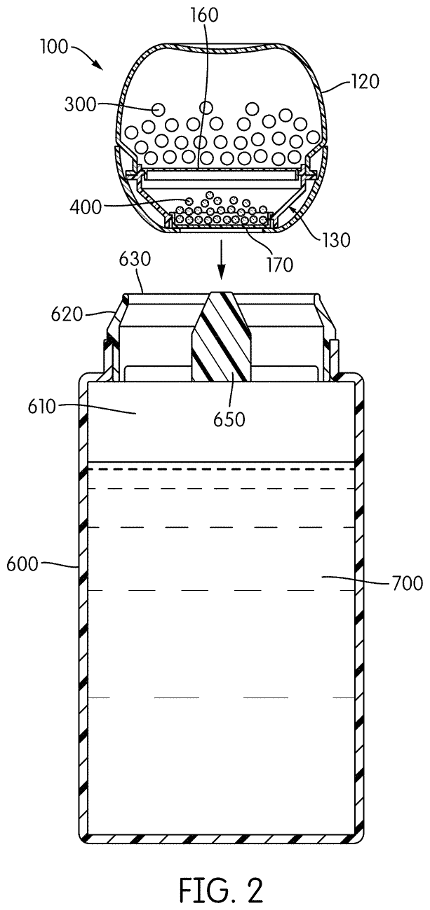

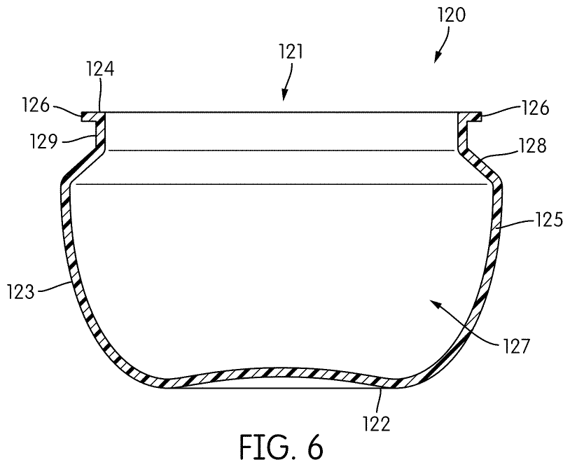

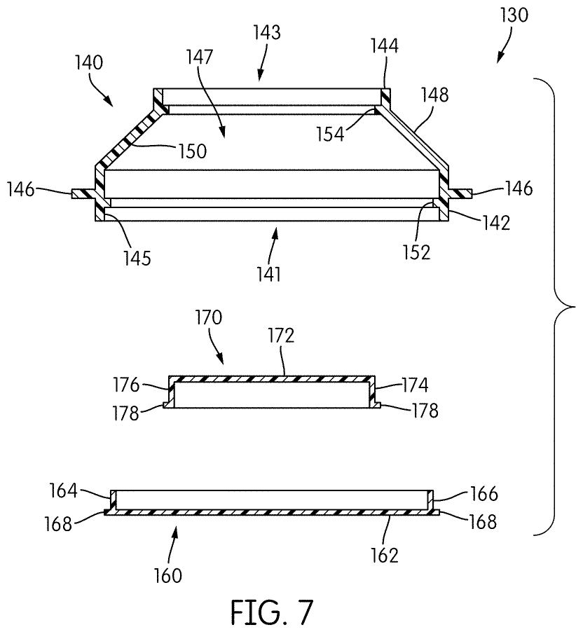

In some embodiments, as shown, for example, in FIGS. 1 and 2, a beverage-ingredient cartridge 100 includes a first container 120 for storing a first beverage ingredient 300 that has an upper end 124 defining an opening 121 (see FIG. 6). Beverage-ingredient cartridge 100 further includes a second container 130 for storing a second beverage ingredient 400 and second container 130 is secured to upper end 124 of first container 120 so as to cover and seal opening 121 of first container 120. Second container 130 includes a body 140 having a first lid 160 and a second lid 170 that can be disengaged from body 140 upon application of a force to second lid 170 (see FIG. 7). When second lid 170 is disengaged from body 140, second beverage ingredient 400 can escape cartridge 100. The force applied to second lid 170 is transferred by second lid 170 to first lid 160 so as to disengage first lid 160 such that first beverage ingredient 300 can also escape cartridge 100. The force applied to first and second lids 160, 170 disengages lids 160, 170 from body 140 of second container 130 such that lids 160, 170 are not broken, ruptured, or otherwise damaged by the application of force to cartridge 100 that disengages lids 160, 170. Thus, displacement of lids 160, 170 from body 140 ensures that beverage ingredients 300, 400 can escape cartridge 100. In some embodiments, first and second lids 160, 170 are entirely disconnected from the rest of beverage-ingredient cartridge 100 upon their disengagement.

Beverage-ingredient cartridge 100 may have any of various shapes, and cartridge 100 in FIG. 1 is shown as having a generally spherical or spheroid configuration. Beverage-ingredient cartridge 100 may have a transverse cross sectional area that is circular. Cartridge 100 may further have a flattened lower end 122 and a flattened upper end 184 so that cartridge 100 does not roll when placed on a surface, which may help to facilitate stacking and storing cartridges 100. Lower end 122 may also form a dome that extends toward an interior of cartridge 100. In some embodiments, beverage-ingredient cartridge 100 may be shaped as a cube, a triangular prism, a hemisphere, an egg-shape, or a rectangular prism, among others.

In some embodiments, beverage-ingredient cartridge 100 may be composed entirely of the same material. However, it is understood that beverage ingredients contained within cartridge 100 are not composed of the same material as cartridge 100. Thus, in embodiments in which cartridge 100 includes a first container 120, a second container 130, and a skirt 180, each of first container 120, second container 130, and skirt 180 may be composed of the same material. The material may be a polymer-based material. In some embodiments, all elements of beverage-ingredient cartridge 100 (including each of first container 120, second container 130, and skirt 180) are composed of the same plastic material such as polypropylene (PP), high density polyethylene (HDPE), or polyethylene terephthalate (PET), among others. In some embodiments, cartridge 100 may be composed entirely of recyclable plastic materials. In some embodiments, components of cartridge 100 may be composed of different materials, and each component is composed of a plastic material, such as PP, HDPE, and PET. By forming the entire cartridge 100 from the same material or from a combination of recyclable plastic materials, cartridge 100 can be easily recycled in a single-stream recycling system without the need to sort the components of cartridge 100 and/or dispose of components that are not recyclable (e.g., metal or paper components). Advantageously, cartridge 100 can be recycled intact without disassembly of its components.

Beverage-ingredient cartridge 100 is used to store one or more beverage ingredients. The term “beverage ingredient” as used herein refers to any edible substance, whether in liquid or solid (“dry”) form, such as sweeteners, colorants, vitamins, minerals, nutrients, adjuncts, or flavorings, including coffee, tea, fruit juice, or concentrates, among others beverage enhancements and combinations thereof. A liquid beverage ingredient may have any viscosity, and may have a low viscosity such that beverage ingredient is water-like or may have a high viscosity such that beverage ingredient is syrup-like. For example, liquid beverage ingredient may be a concentrate, such as a juice, tea or coffee concentrate, an extract, or a honey or syrup, among others. Solid beverage ingredients may be in powdered or granule form, and may be configured to dissolve when mixed with a liquid, such as water. For example, solid beverage ingredient may be sugar, cane sugar, demerara sugar, or raw sugar, or other natural or artificial sweeteners (e.g., stevia), or may be spices, such as cinnamon, or other flavorings.

In some embodiments, cartridge 100 includes a first container 120 and a second container 130. In such embodiments, cartridge 100 is capable of separately storing two beverage ingredients without mixing of the beverage ingredients. Thus, cartridge 100 may store a single beverage ingredient in first container 120 or second container 130 with the other container being empty, cartridge 100 may store the same beverage ingredient in each of first and second containers 120, 130, or cartridge 100 may store two different beverage ingredients, with a first beverage ingredient being stored in first container 120 and a second beverage ingredient being stored in second container 130.

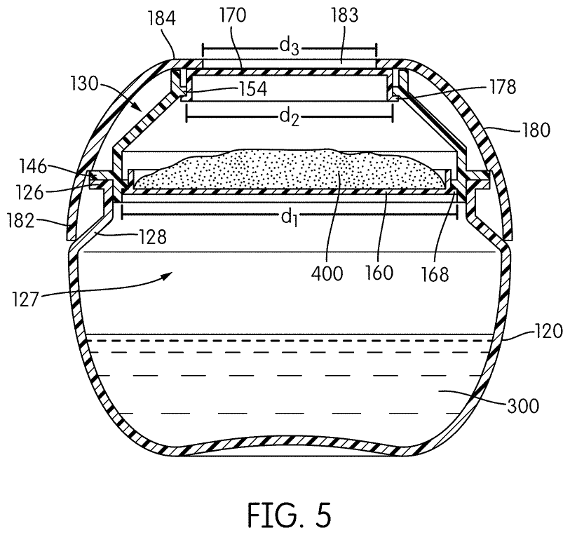

The beverage ingredients stored in cartridge 100 may be different from one another. For example, as shown in FIG. 5, first beverage ingredient 300 may be in liquid form, while second beverage ingredient 400 may be in a solid (e.g., powdered or granule) form. Further, cartridge 100 may be used to store beverage ingredients for producing a specific type of beverage when mixed with a base liquid, such as water or carbonated water. For example, cartridge 100 may store a tea or coffee extract in a first container 120 and a sweetener in a second container 130 of cartridge 100, so that when the contents of cartridge 100 are mixed with water a sweetened and flavored tea or coffee beverage is produced.

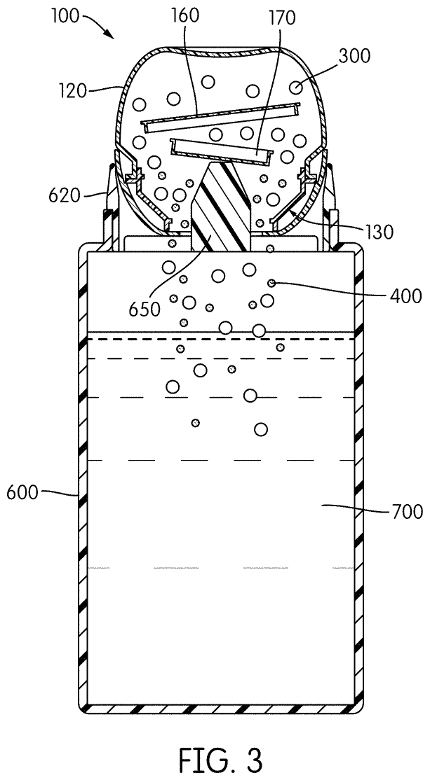

Cartridge 100 may be configured for use with a beverage vessel 600 as shown for example in FIGS. 2 and 3. Beverage vessel 600 may include a body defining an interior volume 610 for storing a quantity of liquid 700, such as water or carbonated water, among others. Beverage vessel 600 has an upper end 620 defining an opening 630 and may also include a cartridge opener 650 located within beverage vessel 600 at upper end 620. Beverage vessel 600 may be configured to removably receive a beverage-ingredient cartridge 100 in opening 630 for dispensing beverage ingredients 300, 400 stored within cartridge 100 into beverage vessel 600 to mix with the liquid 700 within beverage vessel 600.

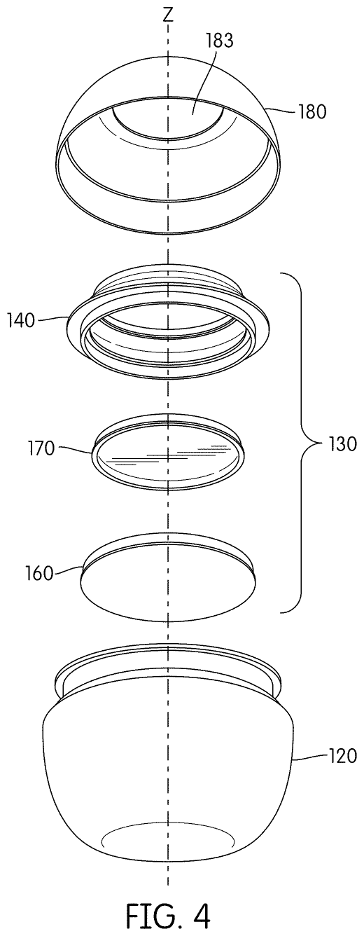

In order to dispense the beverage ingredients 300, 400 stored within cartridge 100, a force may be applied on cartridge 100 so as to disengage first and second lids 160, 170 of second container 130. The force may be applied along a longitudinal axis Z of cartridge 100 (as shown in FIG. 4) in a direction towards an interior of cartridge 100. First and second lids 160, 170 are disengaged from second container 130 without damage to first and second lids 160, 170. Thus, first and second lids 160, 170 remain fully intact and are not pierced, punctured, ruptured, broken, or otherwise physically damaged.

In some embodiments, cartridge 100 may be inverted and partially inserted into upper opening 630 of beverage vessel 600. As cartridge 100 is inserted into upper opening 630, cartridge opener 650 contacts second lid 170 of second container 130 of cartridge 100, applying a force on second lid 170. Once a sufficient force is applied, second lid 170 disengages from second container 130 and second lid 170 transmits the force to first lid 160, which also disengages from second container 130, such that first and second beverage ingredients 300, 400 can escape cartridge 100, as shown in FIG. 3. As lids 160, 170 are fully removed from body 140 of second container 130, beverage ingredients 300, 400 can readily escape cartridge 100. In operation, disengagement of second lid 170 and first lid 160 occurs quickly such that lids 160, 170 are disengaged in rapid succession. Because cartridge 100 is inverted for use with beverage vessel 600, beverage ingredients are automatically evacuated from cartridge 100 by the force of gravity. As beverage ingredients 300, 400 escape cartridge 100, beverage ingredients 300, 400 mix with liquid 700 contained within beverage vessel 600 so as to produce a beverage. Cartridge 100 can then be removed from upper opening 630 of beverage vessel 600 so that a consumer may drink from the beverage vessel 600. After use, the empty cartridge 100 can be recycled intact.

Cartridge opener 650 may have any of various forms, such as a rod having a pointed end for focusing a force on a small area, or the rod may be rounded or blunt. Cartridge opener 650 may also be formed as a pyramidal or triangular shape. While a cartridge opener 650 of a beverage vessel 600 may be used to apply a force to cartridge 100, the force may be applied by any of various means, and any of various tools or implements may be used to apply a force to cartridge 100.

In some embodiments, a force may be applied to cartridge 100 while cartridge 100 is in an upright orientation, as shown in FIG. 1. Thus, a lower end 122 of cartridge 100 may be positioned on a support surface, such that when first and second lids 160, 170 are disengaged from second container 130 of cartridge 100, beverage ingredients 300, 400 will remain within cartridge 100 and can mix with one another within cartridge 100. A consumer may then manually pour the contents of cartridge 100 into a beverage vessel, such as vessel 600, containing water or other base liquid 700 to produce a beverage.

In some embodiments, cartridge 100 includes a first container 120, a second container 130, and a skirt 180, as shown in FIGS. 4-5. First container 120 of cartridge 100 defines an interior volume 127 in which a first beverage ingredient may be stored. As shown in FIG. 6, first container 120 includes a body 125 having a lower end 122 opposite an upper end 124, where lower end 122 is closed and upper end 124 defines an opening 121. Lower end 122 may be flattened so that first container 120 may rest on a surface, such as a tabletop or the like. A beverage ingredient can be deposited into first container 120 through opening 121 and the beverage ingredient can escape first container 120 through opening 121. Body 125 of first container 120 may widen from a lower end 122 towards a shoulder region 128, such that a diameter of body 125 increases from lower end 122 to shoulder region 128. Shoulder region 128 of body 125 is inwardly turned such that first container 120 tapers at shoulder region 128 towards upper end 124. First container 120 may further include a neck 129 extending from shoulder region 128 to upper end 124. In some embodiments, first container 120 further includes a lip 126 extending from a perimeter of upper end 124 of body 125 of first container 120. Lip 126 may extend partially or completely around the perimeter of first container 120. Lip 126 extends outwardly from first container 120 in a direction transverse to a longitudinal axis Z of first container 120.

Cartridge 100 further includes a second container 130, as shown in FIG. 7. Second container 130 may be configured to store a second beverage ingredient, and may be used to store a different beverage ingredient than the beverage ingredient stored in first container 120. In some embodiments, second container 130 includes a body 140, a first lid 160, and a second lid 170. Body 140, first lid 160 and second lid 170 may each have a unitary or one-piece construction so as to simplify assembly and manufacture of cartridge 100, however, in alternate embodiments such components may be made of one or more subparts.

Body 140 of second container 130 defines a lower opening 141 at a lower end 142 of body 140 and an upper opening 143 at an upper end 144 of body 140. First lid 160 may be removably secured to body 140 via an interference fit (e.g., a press fit or friction fit) so as to removably cover lower opening 141. Similarly, second lid 170 may be removably secured to body 140 via an interference fit so as to removably cover upper opening 143. However, first lid 160 and second lid 170 may be removably secured to body 140 by means of other types of removable connections, such as a snap fit, male-female connections, or adhesives. When first lid 160 and second lid 170 are secured to body 140 to cover lower and upper openings 141, 143, respectively, second container 130 defines and fully encloses an interior volume 147 such that second container 130 is capable of storing a beverage ingredient within interior volume 147 of second container 130.

In some embodiments, body 140 has an annular shape such that lower opening 141 and upper opening 143 are each circular in a transverse cross-section. The first and second lids 160, 170 are shaped so as to cover and seal the lower and upper openings 141, 143 and thus may be circular or disk-shaped.

In some embodiments, body 140 of second container 130 tapers from lower end 142 to upper end 144 such that a diameter of lower opening 141 is greater than a diameter of upper opening 143. For example, body 140 may gradually taper from lower end 142 to upper end 144 or may include a tapered region 148, as shown in FIG. 7, in which body 140 tapers from a first diameter to a second diameter that is smaller than the first diameter.

Second container 130 may be secured to first container 120 at upper end 124 of first container 120 such that second container 130 covers and seals opening 121 of first container 120 (see FIG. 5). Body 140 of second container 130 may be secured to first container 120 by any of various fastening methods, including but not limited to welding (including ultrasonic welding), glue, or adhesives, among other fastening methods.

In some embodiments, second container 130 may further include a lip 146 extending from a perimeter of body 140. In such embodiments, lip 146 may extend outwardly from body 140 in a direction transverse to a longitudinal axis Z of second container 130. Lip 146 may extend about the entire perimeter of the body 140 or a portion thereof. Lip 146 of body 140 of second container 130 may be placed in facing engagement with lip 126 of first container 120 and secured thereto by any of the fastening methods described above for securing first container 120 to body 140 of second container 130. In some embodiments, lip 146 extends from a lower end 142 of body 140, such that second container 130 does not extend into, or extends only minimally into an interior of first container 120.

In some embodiments, second container 130 further includes an alignment flange 145 at a lower end 142 of body 140. Alignment flange 145 extends from a perimeter of lower end 142 of body 140 in a direction parallel to a longitudinal axis Z of second container 130. Alignment flange 145 is configured to facilitate positioning of second container 130 on first container 120, wherein alignment flange 145 is inserted into opening 121 of first container 120 such that alignment flange 145 rests against an interior surface of an upper end 124 of first container 120, as best shown in FIG. 5.

In some embodiments, first lid 160 of second container 130 may include a base 162 and a flange 166 extending from a perimeter 164 of base 162. Base 162 may have a generally circular shape, such that first lid 160 is disc-shaped, and is configured to cover lower opening 141 of body 140 of second container 130. Flange 166 may extend from the entire perimeter 164 of base 162 or from a portion thereof. Flange 166 may extend perpendicularly from base 162. Further, flange 166 may vary in height about perimeter 164, such that some portions of the flange 166 have a first height, while other portions have a second height. In some embodiments, a plurality of flanges 166 extend from a perimeter of the first lid 160, and the plurality of flanges 166 may be spaced about perimeter 164 of first lid 160.

Second lid 170 is constructed in a similar manner as set forth with respect to first lid 160. Second lid 170 includes a base 172 and a flange 176 extending from a perimeter 174 of base 172. Base 172 may have a generally circular shape, such that second lid 170 is disc-shaped. Flange 176 may extend from the entire perimeter 174 of base 172 or from a portion thereof. Flange 176 may extend perpendicularly from base 172. Further, flange 176 may vary in height about the perimeter. In some embodiments, a plurality of flanges 176 may extend from perimeter 174 of base 172 and flanges 176 may be spaced about perimeter 174 of second lid 170.

First lid 160 may be secured within lower opening 141 of body 140 of second container 130 by an interference fit (e.g., a press fit or friction fit), which may also include a snap fit. Flanges 166 of first lid 160 may facilitate the interference fit by engaging with interior surface 150 of body 140. Similarly, second lid 170 may be secured within upper opening 143 of body 140 of second container 130 by an interference fit. Flanges 176 of second lid 170 may facilitate the interference fit by engaging with interior surface 150 of body 140. Thus, when second container 130 is assembled, flanges 166, 176 of each lid 160, 170 are directed towards an interior of body 140 of second container 130. First and second lids 160, 170 remain in position within second container 130 for storing a beverage ingredient within second container 130, and can be displaced from body 140 by application of a force to lids 160, 170.

In some embodiments, second container 130 is assembled such that first lid 160 and second lid 170 can only be disengaged from body 140 by applying a force to the first and second lids 160, 170 in a direction from upper end 144 toward lower end 142 of body 140 (a force applied on cartridge 100 from an exterior of cartridge 100 towards an interior of cartridge 100). Thus, first and second lids 160, 170 are configured to be unable to pass through upper opening 143 of body 140 to an exterior of cartridge 100.

In such embodiments, first lid 160 may include a protrusion 168 that extends outwardly from a perimeter thereof. As shown in FIGS. 5 and 7, protrusion 168 of first lid 160 extends outwardly from a base 162 of first lid 160. Protrusion 168 may extend in a transverse direction to a longitudinal axis Z of the second container 130 (and of first lid 160). Protrusion 168 may be configured to engage with a ridge 152 on an interior surface 150 of body 140 at lower end 142 of body 140. Body 140 may include a ridge 152 extending about a perimeter of an interior surface 150 of body 140. When first lid 160 is inserted into lower opening 141, protrusion 168 contacts ridge 152 such that first lid 160 is unable to be further inserted into second container 130. In this way, ridge 152 and protrusion 168 allow first lid 160 to seat within body 140 so that first lid 160 remains in position during transportation and storage of cartridge 100.

Similarly, second lid 170 may also include a protrusion 178 that extends outwardly from second lid 170. Protrusion 178 may extend outwardly from a flange 176 of second lid 170 as shown. Protrusion 178 may be configured to engage with a ridge 154 on interior surface 150 of an upper end 144 of body 140. Ridge 154 may extend about a perimeter of interior surface 150 of body 140. When second lid 170 is inserted into upper opening 143, second lid 170 may pass through interior volume 147 of body 140 towards upper end 144 of body 140 until protrusion 178 engages with ridge 154, such that second lid 170 is unable to pass through upper opening 143 of body 140. Second lid 170 is seated within body 140 when protrusion 178 of second lid 170 engages with ridge 154.

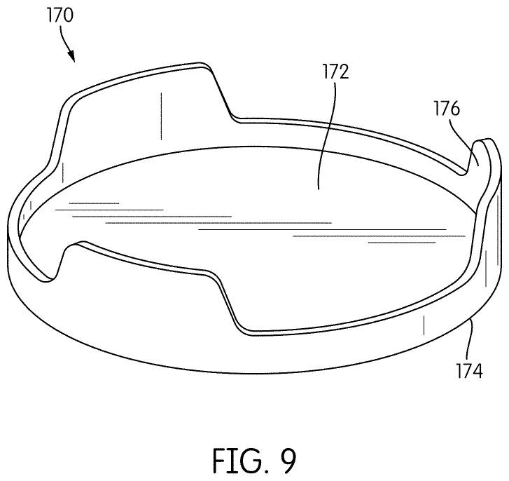

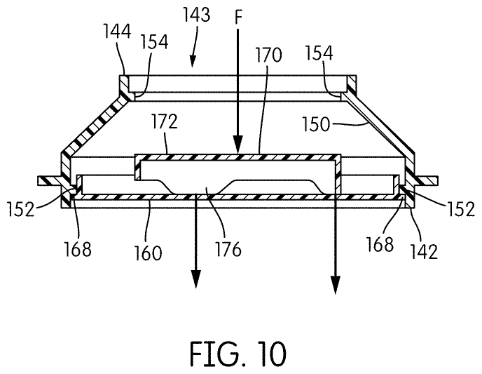

In some embodiments, second lid 170 may have a plurality of flanges 176 spaced around perimeter 174 of base 172 of second lid 170, as shown in FIGS. 9-10. When a force is applied to second lid 170 to displace second lid 170 from body 140 of second container 130, flanges 176 of second lid 170 in turn apply the force to first lid 160. The plurality of flanges 176 may help to focus or concentrate the force applied by second lid 170 on first lid 160. Flanges 176 may help to facilitate displacement of first lid 160 from body 140 of second container 130 so that in operation a consumer can more easily displace first and second lids 160, 170 for dispensing beverage ingredients. Flanges 176 also reduce the amount of travel that second lid 170 undertake before contacting first lid 160, thereby transmitting the force applied to second lid 170 through to first lid 160 more quickly and directly.

In some embodiments, cartridge 100 further includes a skirt 180 (see, e.g., FIGS. 1, 4, and 8). Skirt 180 is configured to enclose second container 130 within cartridge 100. Skirt 180 prevents any portion of second container 130 from escaping cartridge 100 when first and second lids 160, 170 are disengaged from second container 130, while allowing beverage ingredients stored within first and second containers 120, 130 to escape cartridge 100.

Skirt 180 may have a dome-shape or hemispherical shape. Skirt 180 includes a body 185 having a lower end 182 defining a lower opening and an upper end 184 defining an upper opening 183. Skirt 180 may be secured to first container 120 at lower end 182 of skirt 180, as shown for example in FIGS. 1 and 5. Skirt 180 engages with first container 120 along line of connection 190. Lower end 182 of skirt 180 may be secured to shoulder region 128 of first container 120. Skirt 180 may be secured to first container 120 by, for example, welding (including ultrasonic welding), glue, adhesives, or snap-fit, among other fastening methods. When secured to first container 120, skirt 180 covers second container 130 such that second container 130 is positioned within interior volume 187 of skirt 180, as best shown in FIG. 5. Thus, the outer surface of cartridge 100 is defined by an outer surface 123 of first container 120 and an outer surface 188 of skirt 180, and second container 130 is enclosed within cartridge 100. Outer surface 188 of skirt 180 may be substantially continuous with an outer surface 123 of first container 120, such that cartridge 100 has a smooth and continuous outer surface, as shown in FIG. 1.

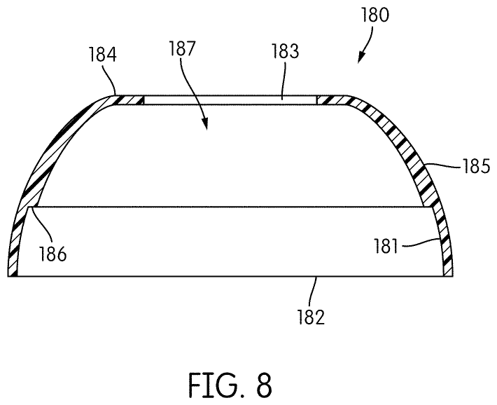

In some embodiments, skirt 180 further includes a ridge 186 on an interior surface 181 of skirt 180, as shown in FIG. 8, that is configured to facilitate connection and securement of skirt 180 to first container 120. Ridge 186 may extend from a perimeter of an interior surface 181 of skirt 180 and is configured to engage with a portion of first container 120, such as a lip 126 of first container 120.

In some embodiments, cartridge 100 is configured to retain first and second lids 160, 170 within cartridge so that first and second lids 160, 170 cannot escape cartridge 100 when disengaged from second container 130 for dispensing beverage ingredients. In such embodiments, first lid 160 may have a maximum diameter, d₁, and second lid 170 may have a maximum diameter d₂, and each of d₁ and d₂ is greater than a diameter, d₃, of opening 183 of skirt 180, as shown in FIG. 5. In this way, first and second lids 160, 170 are sized so as to be unable to pass through opening 183 of skirt 180. This helps to prevent first and second lids 160, 170 of second container 130 from escaping cartridge 100 and entering a beverage vessel, and also helps to keep all components of cartridge 100 together for ease of disposal once beverage ingredients have been dispensed from cartridge 100.

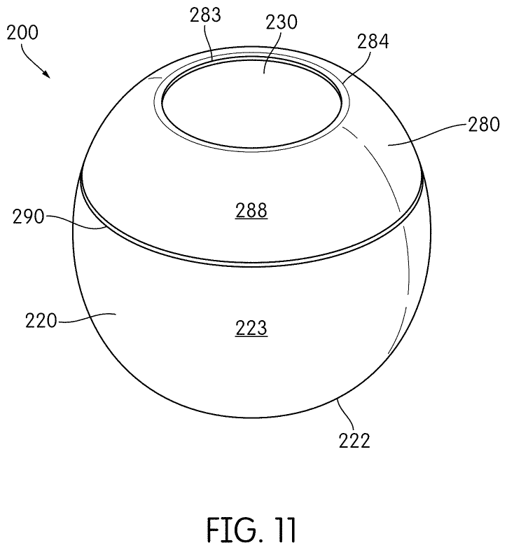

FIGS. 11-19 show a beverage-ingredient cartridge having an alternative configuration, while still sharing many of the features of the beverage-ingredient cartridge shown in FIGS. 1-10 and described above. The beverage-ingredient cartridge of FIGS. 11-19 may also have a first container for storing a first beverage ingredient and a second container for storing a second beverage ingredient. The second container includes a body and a lid that define an interior volume. The second container is positioned within a neck opening of the first container so as to cover the opening and seal the first container. When a force is applied to the second container, the body and lid of the second container are disengaged from the neck of the first container and are pushed into the first container, and the beverage ingredients in each of the first and second containers can escape the cartridge so that the beverage ingredients may be mixed with a liquid to create a beverage.

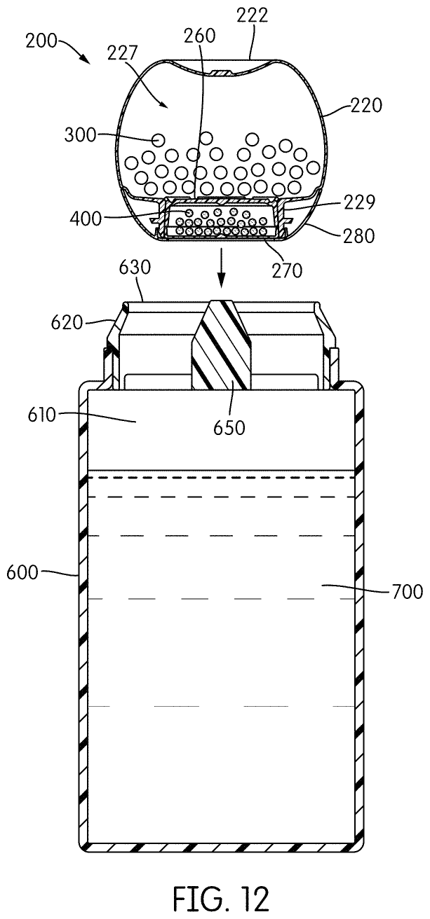

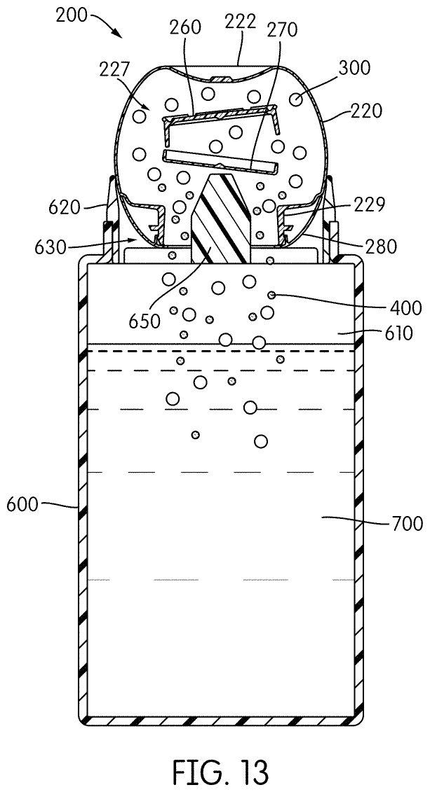

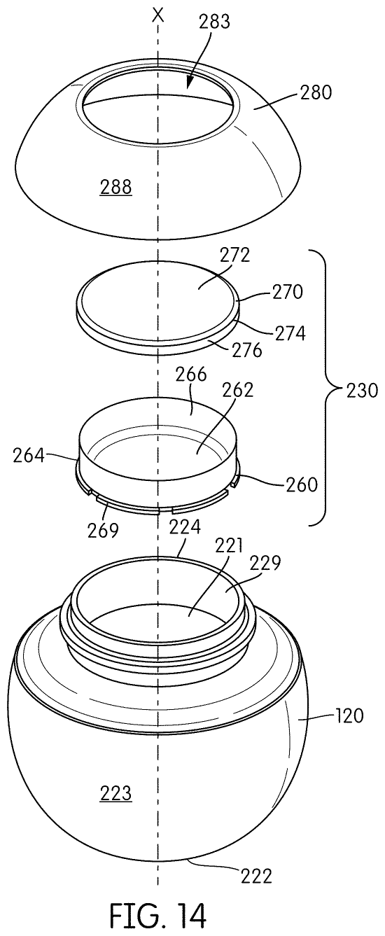

In some embodiments, as shown, for example, in FIGS. 11 and 12, a beverage-ingredient cartridge 200 includes a first container 220 for storing a first beverage ingredient. First container 220 includes a neck 229 defining an opening 221 at an upper end 224 of first container 220 (see also FIGS. 13-14). Beverage-ingredient cartridge 200 further includes a second container 230 for storing a second beverage ingredient, and second container 230 is secured to neck 229 within opening 221 of first container 220 so as to seal first container 220. Second container 230 includes a body 260 and a lid 270 that can be disengaged from neck 229 upon application of a force to lid 270, which transfers the force to body 260. Such a force may be applied by, for example, a cartridge opener 650 of a beverage vessel, such as shown in FIG. 12, when beverage-ingredient cartridge 200 is pushed against cartridge opener 650 by a user.

The force applied to body and lid 260, 270 disengages body and lid 260, 270 from neck 229 of first container 220 such that body and lid 260, 270 are not broken, ruptured, or otherwise damaged by the application of force to cartridge 200. Displacement of body and lid 260, 270 from neck 229 of first container 220 into an interior volume of first container 220 ensures that beverage ingredients can escape cartridge 200 via opening 221. In some embodiments, body and lid 260, 270 are entirely disconnected from the rest of beverage-ingredient cartridge 200 upon their disengagement.

Similar to beverage-ingredient cartridge 100, beverage-ingredient cartridge 200 may have any of various shapes, and cartridge 200 in FIG. 11 is shown as having a generally spherical or spheroid configuration. Beverage-ingredient cartridge 200 may have a transverse cross sectional area that is circular. Cartridge 200 may further have a flattened lower end 222 and a flattened upper end 284 so that cartridge 200 does not roll when placed on a surface, which may help to facilitate stacking and storage of cartridges 200. Lower end 222 may also form a dome that extends toward an interior of cartridge 200. In some embodiments, beverage-ingredient cartridge 200 may be shaped as a cube, a triangular prism, a hemisphere, an egg-shape, or a rectangular prism, among others.

In some embodiments, beverage-ingredient cartridge 200 may be composed entirely of the same material. Thus, in embodiments in which cartridge 200 includes a first container 220, a second container 230, and a skirt 280, each of first container 220, second container 230, and skirt 280 may be composed of the same material. In some embodiments, beverage-ingredient cartridge 200 may be composed entirely of recyclable plastic materials. For example, first container 220 may be composed of a first recyclable plastic, such as PET, and second container 230 may be composed of a second recyclable plastic, such as PP. Thus, the components of cartridge 200 may be composed of different types of plastic, and cartridge 200 includes no metal components. As cartridge 200 is composed entirely of recyclable plastic materials, cartridge 200 may be recycled without disassembly or sorting of components of cartridge 200. Further, cartridge 200 may be composed of any of the same materials as discussed above with respect to cartridge 100.

Cartridge 200 may store any of the various types and combinations of beverage ingredients, such as liquid or solid (e.g., powdered or granule) beverage ingredients as discussed above with respect to cartridge 100. Similar to cartridge 100, first container 220 of cartridge 200 and second container 230 of cartridge 200 are capable of separately storing two beverage ingredients without mixing of the beverage ingredients. Thus, first and second containers 220, 230 of cartridge 200 may each store the same beverage ingredient or may store different beverage ingredients. Cartridge 200 may store a single beverage ingredient in first container 220 or second container 230 with the other container being empty, cartridge 200 may store the same beverage ingredient in each of first and second containers 220, 230, or cartridge 200 may store two different beverage ingredients, with a first beverage ingredient being stored in first container 220 and a second beverage ingredient being stored in second container 230. In some embodiments, for example, first container 220 of cartridge 200 may store a liquid beverage ingredient, such as a juice concentrate, and second container 230 may store a powdered beverage ingredient, such as a sweetener.

Cartridge 200 functions similarly to cartridge 100 and is configured for use with a beverage vessel 600, as shown in FIGS. 12-13. A beverage vessel 600 may be configured to removably receive beverage-ingredient cartridge 200 in an opening 630 at an upper end 620 thereof for dispensing beverage ingredients 300, 400 stored within cartridge 200 into beverage vessel 600 to mix with a liquid 700 contained by beverage vessel 600. In order to open cartridge 200 to dispense the stored beverage ingredients 300, 400, a force may be applied to cartridge 200 to disengage body and lid 260, 270 of second container 230 from a neck 229 of first container 220. The force may be applied along a longitudinal axis X of cartridge 200 in a direction towards an interior of cartridge 200 (see FIG. 12). Body and lid 260, 270 are disengaged from first container 220 without damage to body and lid 260, 270. Thus, body and lid 260, 270 remain fully intact and are not pierced, punctured, ruptured, broken, or otherwise physically damaged.

With reference to FIGS. 12 and 13, in some embodiments, cartridge 200 may be inverted and partially inserted into upper opening 630 of beverage vessel 600 in the same manner as discussed with respect to cartridge 100. A cartridge opener 650 of beverage vessel 600 contacts lid 270 of second container 230 of cartridge 200, applying a force on lid 270, and lid 270 transmits the force to body 260. Such application and transmission of force causes body 260 to disengage from neck 229 of first container 220 (by being pushed into the interior of first container 220) and lid 270 to disengage from neck 229 of first container 220 (also by being pushed into the interior of first container 220), such that first and second beverage ingredients 300, 400 can escape cartridge 200. As body and lid 260, 270 are fully removed from opening 221 defined by neck 229 of first container 220 they also separate from each other, thereby allowing beverage ingredients 300, 400 to easily escape cartridge 200. Disengagement of body and lid 260, 270 occurs in rapid succession, and as cartridge 200 is inverted, beverage ingredients 300, 400 are automatically evacuated from cartridge 200 by the force of gravity.

A force may be applied to cartridge 200 via any of various tools or implements, or by a cartridge opener 650 of a beverage vessel 600 having any of various shapes and configurations. Further, in some embodiments, a force may be applied to cartridge 200 while cartridge 200 is in an upright orientation, as shown in FIG. 11, such that beverage ingredients remain within cartridge 200 and can mix within cartridge 200, and the contents may then be manually poured into a vessel containing a liquid to produce a beverage when combined with the beverage ingredients. No matter the manner of its use, after use, cartridge 200 may be recycled intact with body and lid 260, 270 loosely retained within first container 220 of cartridge 200 and unable to escape therefrom.

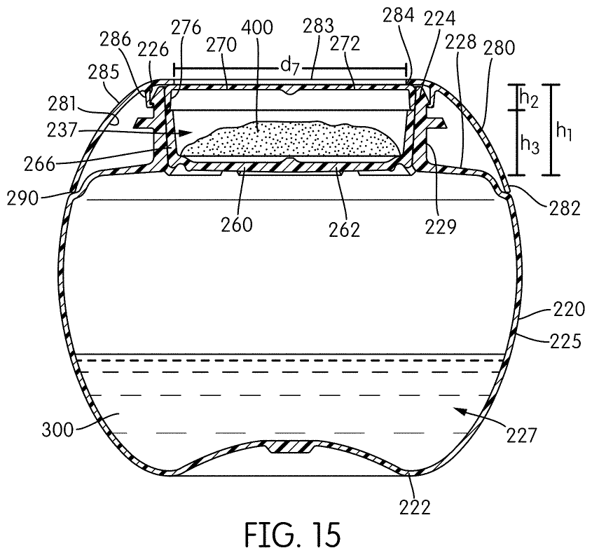

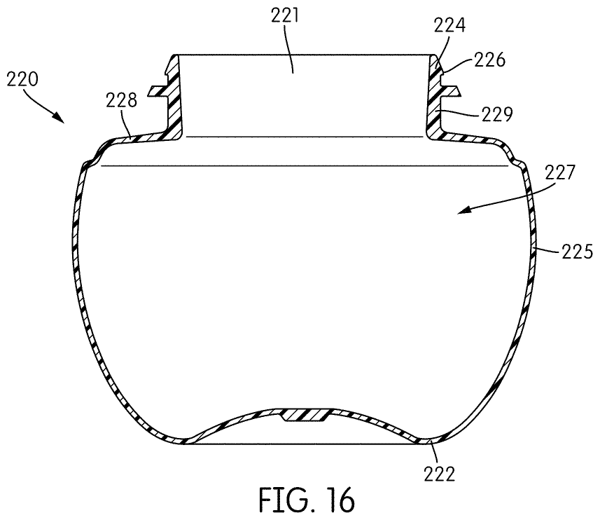

In some embodiments, cartridge 200 includes a first container 220, a second container 230, and a skirt 280, as shown in FIGS. 14-15. First container 220 of cartridge 200 defines an interior volume 227 in which a first beverage ingredient may be stored, as best shown in FIG. 16. First container 220 includes a body 225 having a lower end 222 opposite an upper end 224, wherein lower end 222 is closed and upper end 224 defines an opening 221. A beverage ingredient can be deposited into first container 220 through opening 221 and the beverage ingredient can escape first container 220 through opening 221. Lower end 222 of first container 220 may be flattened so that first container 220 can rest on a surface, such as a tabletop or the like. Body 225 of first container 220 may widen from a lower end 222 towards a shoulder region 228, such that a diameter of body 225 increases from lower end 222 toward shoulder region 228. Shoulder region 228 of body 225 is inwardly turned such that first container 220 tapers at shoulder region 228 towards upper end 224. First container 220 may further include a neck 229 extending from shoulder region 228 to upper end 224.

In some embodiments, first container 220 further includes a lip 226 extending from a perimeter of neck 229 at upper end 224 of first container 220. Lip 226 may be configured for securing a skirt 280 to first container 220. Lip 226 may extend partially or completely around a perimeter of neck 229 of first container 220. Lip 226 extends outwardly from neck 229 of first container 120 in a direction transverse to a longitudinal axis X of first container 220. Lip 226 may be configured to mate with a ridge of skirt 280 for securing skirt 280 to first container 220 (e.g., via a snap fit), where such engagement is permanent (i.e., skirt 280 is not removable from first container 220 without damaging skirt 280 or first container 220).

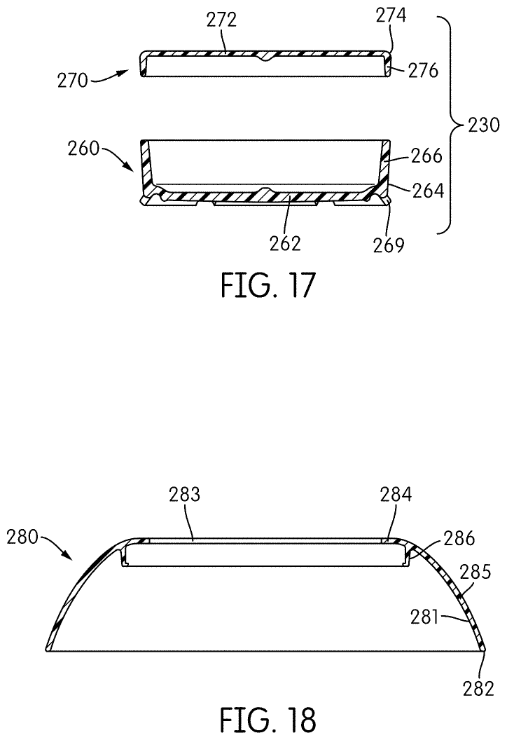

Cartridge 200 further includes a second container 230, as shown for example at FIG. 17. Second container 230 may be configured to store a second beverage ingredient, and may be used to store a different beverage ingredient than the beverage ingredient stored in first container 220. In some embodiments, second container 230 includes a body 260 and a lid 270. As shown, each of body 260 and lid 270 has a unitary (i.e., one-piece construction). Such construction is beneficial, for example, by simplifying manufacture and assembly, and reducing the complexity of cartridge 200. In alternate embodiments, however, such components may be made of one or more subparts.

Second container 230 may be removably secured within opening 221 of first container 220 at neck 229 of first container 220. Second container 230, and thus body and lid 260, 270 of second container 230 may be secured to neck 229 within opening 221 via an interference fit (e.g., a press fit or friction fit) so as to removably cover opening 221 of first container 220. However, body and lid 260, 270 may be secured to neck 229 of first container 220 by means of other types of removable connections, such as a snap fit, male-female connections, or adhesives. When body and lid 260, 270 are secured to neck 229 to cover and seal opening 221 of first container 220, body and lid 260, 270 also define an interior volume 237 of second container 230 for storing a beverage ingredient (see FIG. 15).

In some embodiments, second container 230 has a circular transverse cross sectional shape so as to fit within a circular opening 221 defined by neck 229 of first container 220. Thus, each of body and lid 260, 270 also have a circular transverse cross-sectional shape. However, it is understood that second container 230 is shaped to fit within opening 221 of first container 220, and thus in embodiments in which first container 220 defines an opening 221 having a different shape, such as a square shape, second container 230 may be formed so as to have the same cross sectional shape so that second container 230 can be secured to neck 229 of first container 220 within opening 221 via an interference-fit.

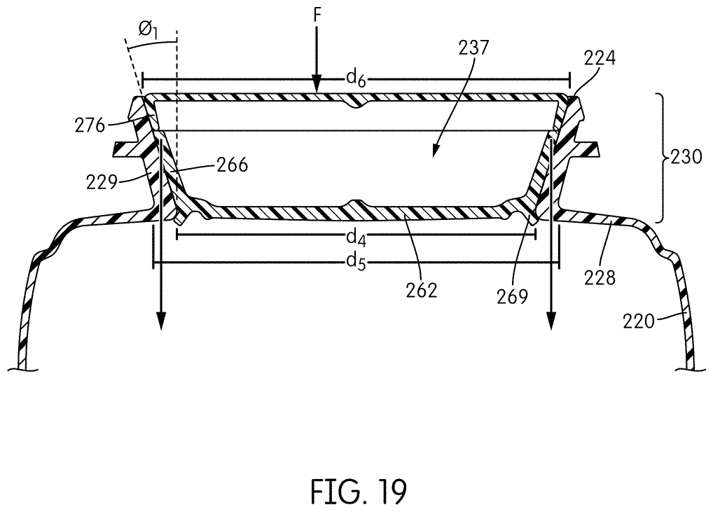

In some embodiments, neck 229 of first container 220 may have a slight taper from an upper end 224 toward shoulder region 228 of first container 220, as shown for example at FIG. 19 (tapering features are exaggerated in FIG. 19 for illustration). Thus, opening 221 of first container 220 may have a greater diameter at an upper end 224 of neck 229 than at shoulder region 228. Accordingly, the walls of first container 220 that form neck 229 may form an angle θ₁ relative to a longitudinal axis X of cartridge 200. In some embodiments, angle θ₁ may be 1 to about 10 degrees. The angled neck 229 helps to secure body and lid 260, 270 within neck 229 and to prevent accidental disengagement of body and lid 260, 270 from neck 229 of cartridge 200. Thus, when a force is applied to lid 270 of second container 230, and a force is applied by lid 270 to body 260, body and lid 260, 270 and/or neck 229 may deform or bend slightly in order to allow body and lid 260, 270 to fit through opening 221 and enter interior volume 227 of first container 220.

Once body and lid 260, 270 enter interior volume 227 of first container 220, body and lid 260, 270 are unable to escape from first container 220, as a maximum diameter d₅ of body 260, and a maximum diameter d₆ of lid 270 are each slightly greater than a diameter d₄ of opening 221 at shoulder region 228 of first container 220 (i.e., a minimum diameter of opening 221). Further, in some embodiments, cartridge 200 further includes a skirt 280 having an upper opening 283 that has a diameter d₇ that is smaller than a diameter of lid 270 so as to prevent lid 270, or body 260, from escaping cartridge 200, as described in further detail below.

In some embodiments, body 260 of second container 230 may include a base 262 and a flange 266 extending from a perimeter 264 of base 262 (see FIGS. 17 and 19). Base 262 may have a generally circular or disk-like shape. Flange 266 may extend from the entire perimeter 264 of base 262 in a direction of longitudinal axis X or at a slight angle relative to the longitudinal axis X. The angle of flange 266 relative to a longitudinal axis X may be the same as the angle θ₁ of the neck 229 of first container 220 so that flange 266 may rest against neck 229 when body 260 is secured to first container 220. Body 260 having a base 262 and flange 266 is shaped as a cup for holding a beverage ingredient, such as a powder or granules, among other types of beverage ingredients.

In some embodiments, body 260 of second container 230 may include a lip 269 extending from a perimeter 264 of body 260 at base 262 of body 260, as shown, for example, in FIG. 19. Lip 269 may extend outwardly from body 260 of second container 230 so as to increase a maximum diameter of body 260. Body 260 may include a plurality of lips 269 extending outwardly from perimeter 264 of body 260 or may include a single lip 269. Further, the lip(s) 269 may extend partially or fully about perimeter 264 of body 260. Lip 269 is configured to prevent body 260 from escaping from neck 229 of first container 220 to an exterior of cartridge 200.

Lip 269 provides body 260 with a diameter that is greater than a diameter d₄ of opening 221 of first container 220 to help retain body 260 within neck 229. When body 260 is secured within neck 229 of first container 220, lip 269 may engage a lower end of neck 229 at a shoulder region 228 of first container 220 within first container 220. For instance, upon assembly of cartridge 200, body 260 of second container 230 may be pressed into neck 229 until lip(s) 269 snap through the base of neck 229 to lock body 260 in place relative to first container 220 (e.g., by a snap-fit, and interference fit, or both). Before body 260 of second container 230 is engaged in this way with first container 220, first container 220 may be filled with first beverage ingredient 300 (e.g., a liquid) such that engagement of body 260 seals first beverage ingredient 300 within first container 220.

When first container 220 is filled with a beverage ingredient, such as a hot liquid, and body 260 of second container 230 is secured to neck 229 of first container 220 so as to cover and seal opening 221, pressure may build within the enclosed interior volume 227 of first container 220. Thus, lip 269 helps to maintain body 260 of second container 230 in position within neck 229 of first container 220 so that pressure within interior volume 227 of first container 220 does not eject or otherwise displace body 260 of second container 230.

Similar to body 260, lid 270 may include a base 272 and a flange 276 extending from a perimeter 274 of base 272 (see FIGS. 17 and 19). Base 272 may have a generally circular or disk-like shape. Flange 276 may extend from the entire perimeter of base 272 in a direction of longitudinal axis X or at a slight angle relative to the longitudinal axis X, wherein the angle is the same as the angle of neck 229 of first container 220 so that flange 276 may rest against neck 229 when lid 270 of second container 230 is secured to neck 229 of first container 220. In some embodiments, flange 276 may extend perpendicularly from base 272. Lid 270 covers body 260 of second container 230 so as to define and enclose an interior volume 237 of second container 230.

When second container 230 is secured within neck 229 of first container 220, second container 230 is arranged such that flange 266 of body 260 engages flange 276 of lid 270. Thus, body 260 of second container 230 is arranged within neck 229 of first container 220 toward shoulder region 228 of first container 220 and such that flange 266 of body 260 extends in an upward direction. Lid 270 of second container 230 is arranged within neck 229 toward upper end 224 of first container 220, such that lid 270 is above body 260, and such that flange 276 of lid 270 extends in a downward direction toward body 260 and toward an interior of cartridge 200. When body and lid 260, 270 of second container 230 are arranged in neck 229 of first container 220, flange 266 of body 260 contacts flange 276 of lid 270. The flanges 266, 276 may be in facing engagement and may meet in an end-to-end manner.

During assembly of cartridge 200, body 260 of second container 230 is removably secured within neck 229 of first container 220, such as by an interference fit, so as to removably cover and seal opening 221 of first container 220, enclosing an interior volume 227 of first container 220, which may include a beverage ingredient therein. Body 260 of second container 230 is positioned within opening 221 at a lower end of neck 229 adjacent shoulder region 228 of first container 220. A beverage ingredient, such as a powdered beverage ingredient, may be positioned in body 260 of second container 230. Once body 260 is removably secured within neck 229, lid 270 may be positioned within neck 229 so as to enclose interior volume 237 of second container 230 and a beverage ingredient therein. Body and lid 260, 270 may be removably secured to neck 229 of first container 220 such as by an interference fit, among other securement methods, such that flanges 266, 276 are in contact with an interior surface of neck 229 of first container 220. In some embodiments, body and lid 260, 270 of second container 230 are not secured to one another, and instead flanges 266, 276 of body and lid 260, 270, respectively, simply meet in an end-to-end manner to define an interior volume of second container 230. In this way, when a force is applied to second container 230 such that body and lid 260, 270 are disengaged from neck 229 of first container 220, body and lid 260, 270 readily separate from one another so as to release a beverage ingredient stored within second container 230.

In some embodiments, neck 229 of first container 220 has a height h₁, as measured in a direction of a longitudinal axis of cartridge 200 from shoulder region 228 to upper end 224 of neck 229, as best shown in FIG. 15. Second container 230 may have a height that is the same as or slightly less than height h₁ of neck 229 such that second container 230 is supported within neck 229 and does not extend above upper end 224 of neck 229. Body 260 of second container 230 may have a height h₃ as measured in a longitudinal direction from base 262 to a terminal end of flange 266, and lid 270 of second container 230 may have a height h₂ as measured in a longitudinal direction from base 272 to a terminal end of flange 276. As second container 230 is assembled by placing flange 276 of lid 270 in facing engagement with flange 266 of body 260 such that flanges 276, 266 meet in an end-to-end manner, the combined heights of body and lid, i.e., h₂+h₃, is the height of second container 230. The combined height of body and lid 260, 270 is equal to or less than the height h₁ of the neck 229. In some embodiments, h₃ may be greater than h₂, so that body 260 resembles a cup for holding a beverage ingredient, such as a powder, and lid 270 covers body 260 in order to enclose the beverage ingredient within second container 230.

In some embodiments, cartridge 200 further includes a skirt 280, as shown for example in FIG. 18. Skirt 280 is configured to prevent any portion of second container 230 from escaping cartridge 200, such as when body and lid 260, 270 are disengaged from neck 229 of first container 220, while allowing beverage ingredients stored within first and second containers 220, 230 to escape cartridge 200.

Skirt 280 may have a dome-shape or hemi-spherical shape. Skirt 280 includes a body 285 having a lower end 282 defining a lower opening and an upper end 284 defining an upper opening 283. Skirt 280 is positioned at upper end of first container 220 so as to form an upper portion of cartridge 200. Thus, an outer surface of cartridge 200 is defined by an outer surface 223 of first container 220 and an outer surface 288 of skirt 280 (as shown in FIG. 11), and second container 230 is enclosed within cartridge 200. Outer surface 288 of skirt 280 may be substantially continuous with an outer surface 223 of first container 220, such that cartridge 200 has a smooth and continuous outer surface.

In some embodiments, skirt 280 further includes a ridge 286 (see FIGS. 18-19) on an interior surface 281 of skirt 280 that is configured to facilitate connection and securement of skirt 280 to first container 220. Ridge 286 may extend from a perimeter of an interior surface 281 of skirt 280, such that ridge 286 has an annular configuration, and ridge 286 is configured to engage with a portion of first container 220, such as a lip 226 of first container 220. Thus, skirt 280 may be secured to first container 220 such as by engagement of ridge 286 of skirt 280 with lip 226 of neck 229 of first container 220, as shown for example at FIG. 12. Ridge 286 and lip 226 may be further secured by any of various fastening methods, including but not limited to welding (including ultrasonic welding), glue, or adhesives, among other fastening methods, such that skirt 280 cannot be readily removed from first container 220. In this way, skirt 280 helps to maintain second container 230 within cartridge 200 and prevents tampering.

In some embodiments, skirt 280 may alternatively or additionally be secured to first container 220 at a lower end 282 of skirt 280, as shown for example in FIG. 15. Skirt 180 engages with first container 220 along line of connection 290 (see FIG. 11). Lower end 282 of skirt 280 may be in contact with, and is optionally secured to shoulder region 228 of first container 220. Lower end 282 of skirt 280 may be secured to first container 220 by, for example, welding (including ultrasonic welding), glue, adhesives, or snap-fit, among other fastening methods. When skirt 280 is secured to first container 220, second container 230 is accessible through upper opening 283 of skirt 280. In this way, a cartridge opener (e.g., cartridge opener 650) or other tool may be used to apply force to second container 230 so that cartridge 200 is opened and the stored beverage ingredients can be dispensed.

In some embodiments, cartridge 200 is configured to retain body and lid 260, 270 of second container 230 within cartridge 200 so that body and lid 260, 270 cannot escape cartridge 200 when disengaged from first container 220. In such embodiments, body 260 may have a maximum diameter, d₄, and lid 270 may have a maximum diameter d₅, and each of d₄ and d₅ is greater than a diameter, d₇, of upper opening 283 of skirt 280, as shown in FIG. 15. In this way, body and lid 260, 270 are sized so as to be unable to pass through opening 283 of skirt 280. This helps to prevent body and lid 260, 270 of second container 230 from escaping cartridge 200 and entering a beverage vessel, and also helps to keep all components of cartridge 200 together for ease of disposal once beverage ingredients have been dispensed from cartridge 200.

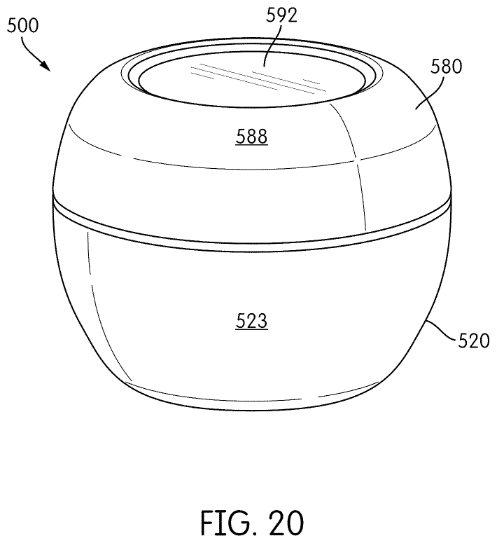

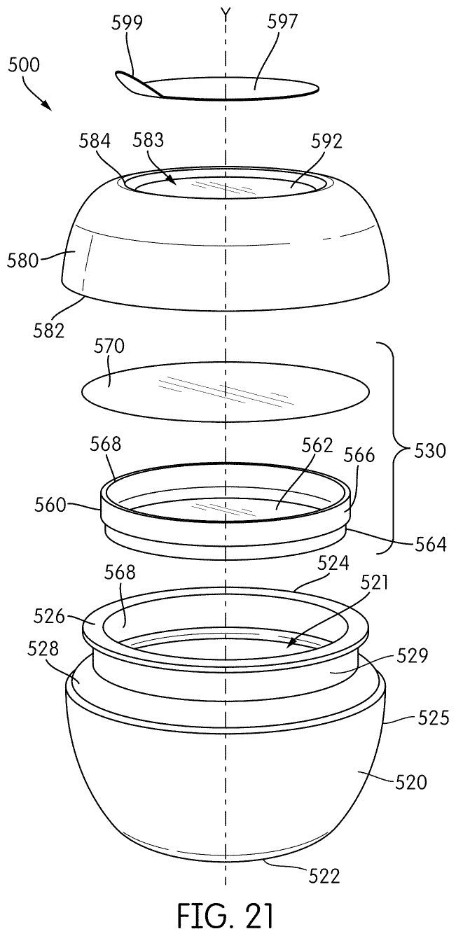

Some embodiments described herein relate to a beverage-ingredient cartridge 500 as shown for example in FIGS. 20-21. Beverage-ingredient cartridge 500 may include a first container 520 for storing a first beverage ingredient 300, a second container 530 for storing a second beverage ingredient, and a skirt 580 having an opening 583 that provides access to second container 530.

Cartridge 500 may be formed in substantially the same manner as described above with respect to beverage-ingredient cartridge 200. First container 520 may be formed in the same manner as described above with respect to first container 220, and second container 530 may include a body 560 formed in the same manner as body 260 of cartridge 200. However, beverage-ingredient cartridge 500 differs from beverage-ingredient cartridge 200 primarily in that second container 530 includes a plastic film 570 configured to cover and seal body 560 of second container 530 so as to enclose a second beverage ingredient 400 within second container 530. Thus, second container 530 of cartridge 500 does not include a lid (e.g., lid 270 as in cartridge 200) and instead uses plastic film 570 to enclose second container 530 (e.g., plastic film 570 forms a cover for second container 530.

In some embodiments, and similar to beverage-ingredient cartridge 200, beverage-ingredient cartridge 500 includes a first container 520 having a body 525 having a lower end 522 and an upper end 524. Body 525 may taper towards upper end 524 at a shoulder region 528, and may have a neck 529 that extends from shoulder region 528. Neck 529 may be parallel to a longitudinal axis Y of cartridge 500. In some embodiments, a lip 526 extends outwardly from neck 529 at upper end 524, and lip 526 may extend transversely to longitudinal axis Y of cartridge 500.

Beverage-ingredient cartridge 500 may further include a second container 530 having a body 560 and a plastic film 570. Body 560 may include a base 562 and a flange 566 extending from a perimeter 564 of base 562 so as to form a cup-shape. Body 560 is configured to be removably secured within opening 521 at neck 529 of first container 520, such as by an interference fit (e.g., a press fit or friction fit). Thus, body 560 serves to seal and enclose opening 521 of first container 520, and body 560 also defines a portion of second container 530 for storing a second beverage ingredient.

In order to seal second container 530, a plastic film 570 is secured to upper end 568 of body 560. Plastic film 570 may be a thin, flexible film. Plastic film 570 is configured to be torn, punctured, ruptured, or the like, during a beverage-making operation involving cartridge 500. For example, plastic film 570 may be torn by cartridge opener 650 when used with a beverage vessel 600 (see, e.g., FIGS. 2, 12) or may be torn by a component of cartridge 500 as discussed in further detail below. Plastic film 570 may facilitate evacuation of second beverage ingredient from cartridge 500, as plastic film 570 may be readily torn under the right conditions, i.e., may be torn by application of a force applied during an operation intended to open cartridge 500 (e.g., a beverage-making operation).

Plastic film 570 may be formed of various types of recyclable plastic materials, including polyethylene or polypropylene, among others. Plastic film 570 may be formed without metal or other materials that are not recyclable together with plastic. In fact, all components of cartridge 500 (like cartridges 100 and 200) may be formed of plastic, and without metal or other materials that are not recyclable with plastic. As plastic film 570 is composed of a recyclable material, cartridge 500 can be easily recycled in a single-stream recycling system without the need to sort the components of cartridge 500 and/or dispose of components that are not recyclable (e.g., metal or paper components). Advantageously, cartridge 500 can be recycled intact without disassembly of its components.

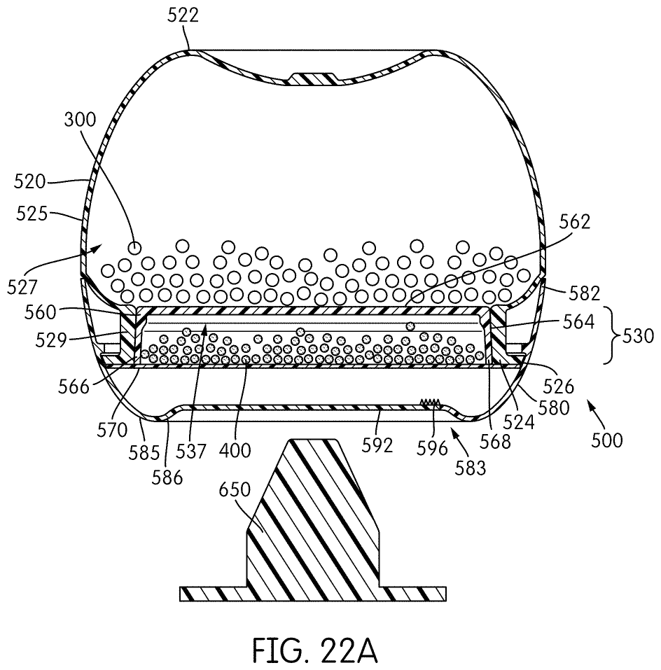

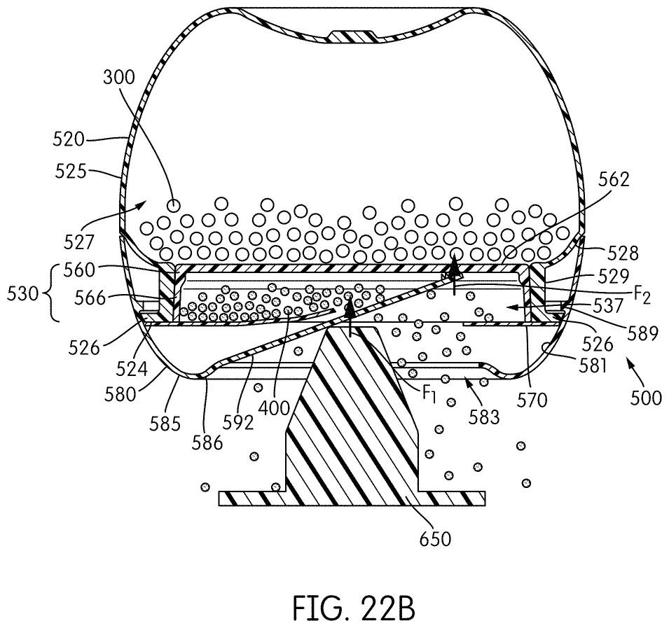

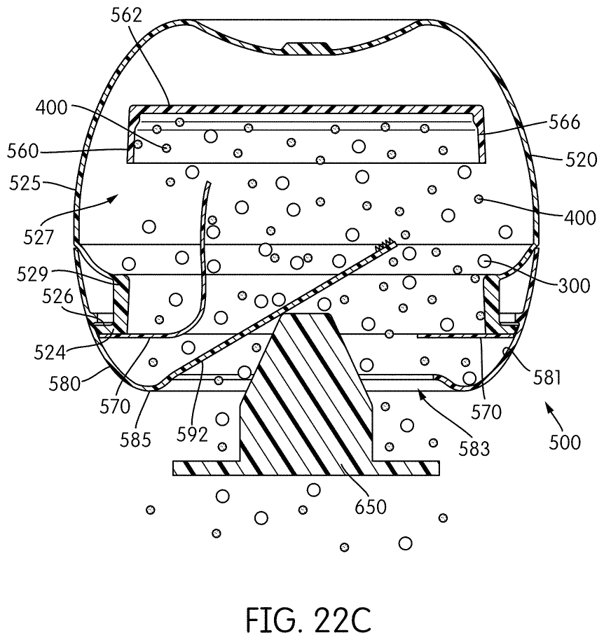

In order to fill beverage-ingredient cartridge 500, first container 520 may be filled with a first beverage ingredient 300, such as a liquid beverage ingredient, through opening 521. Once first container 520 is filled, body 560 of second container 530 is positioned within opening 521 of neck 529 of first container 520 so as to enclose first container 520 and first beverage ingredient 300 therein. Body 560 may be filled with a second beverage ingredient 400, such as a dry beverage ingredient, via an open upper end 568 of body 560. Once body 560 is filled with second beverage ingredient 400, plastic film 570 may be positioned over an upper end 568 of body 560 to enclose interior volume 537 of second container 530 and second beverage ingredient 400. Plastic film 570 may be secured to body 560 by adhesives, glue, bonding, or welding, including ultrasonic welding, among other fastening methods. In some embodiments, plastic film 570 may also be secured to upper end 524 of first container 520, as shown in FIG. 22A, such as to a lip 526 of upper end 524 of first container 520. This helps to ensure that second container 530 is fully sealed.

Beverage-ingredient cartridge 500 further includes a skirt 580, as shown for example in FIGS. 20 and 21. Skirt 580 of cartridge 500 may be formed in the same manner as skirt 280 of cartridge 200, as shown for example in FIGS. 14 and 18. Skirt 580 may have a dome-shape or hemi-spherical shape. Skirt 580 includes a body 585 having a lower end 582 defining a lower opening and an upper end 584 defining an upper opening 583. Skirt 580 is positioned on first container 520 so as to form an upper portion of cartridge 500, and may be positioned with lower end 582 in contact with a shoulder region 528 of first container 520. Skirt 580 may be secured to first container 520 by snap-fit, or may be secured via glue, adhesives, or welding, such as ultrasonic welding. In some embodiments, skirt 580 may include a ridge 589 extending from an interior surface 581 of skirt 580 configured to engage a portion of first container 520, such as a lip 526 of first container 520. An outer surface of cartridge 500 is defined by an outer surface 523 of first container 520 (e.g., below skirt 580) and an outer surface 588 of skirt 580 (as shown in FIG. 20). As shown, for example, in FIG. 22A, second container 530 is enclosed within cartridge 500, and skirt 580 may prevent body 560 of second container 530 from escaping cartridge 500. Specifically, upper opening 583 of skirt 580 may be sized so as to have a diameter smaller than a diameter of body 560 of second container 530, such that when body 560 is disengaged from first container 520, body 560 cannot escape cartridge 500 via upper opening 583 of skirt 580.

In some embodiments, skirt 580 of cartridge 500 may further include a door 592 that, when closed, covers upper opening 583 of skirt 580. Door 592 may be movable between a first position in which door 592 covers opening 583 of skirt 580, and a second position in which door 592 is rotated or pivoted inwardly toward second container 530. Door 592 may be shaped so as to fit within and seal opening 583 of skirt 580, and for example, may have a circular shape so as to close a circular opening 583 of skirt 580. Door 592 may include a hinge 586 that connects door 592 to skirt 580 and allows door 592 to rotate. Hinge 586 may be in the form of a living hinge such that skirt 580 and door 592 may be integrally formed.

Door 592 may facilitate dispensing of beverage ingredients from cartridge 500, as shown in FIGS. 22A-22C. In order to dispense beverage ingredients from a beverage ingredient cartridge 500, cartridge 500 containing a first and second beverage ingredient 300, 400 may be inverted and aligned with a cartridge opener 650 as shown in FIG. 22A. Cartridge opener 650 may apply a force F₁ on door 592 of cartridge 500 so as to cause door 592 to rotate inwardly to the second position, as shown in FIG. 22B. As door 592 rotates inwardly, door 592 contacts plastic film 570 and the force F₁ (represented by the arrows in FIG. 22B) applied by cartridge opener 650 on door 592 causes plastic film 570 to tear or rupture, allowing a beverage ingredient 400 to escape therefrom. As door 592 continues to rotate, door 592 also applies a force F₂ on body 560 of second container 530 so as to disengage body 560 from neck 529 of first container 520, such that body 560 is pushed into an interior volume 527 of first container 520, as shown in FIG. 22C. As a result, first beverage ingredient 300 may also escape from first container 520. As body 560 of second container 530 is configured to fit tightly within neck 529 of first container 520, the force F₂ applied to body 560 may cause body 560 to deform slightly such that body 560 may pass into an interior volume 527 of first container 520.

In some embodiments, door 592 may further include a tear initiating protrusion 596 to facilitate tearing, rupturing or breaking of the plastic film 570. Tear initiating protrusion 596 may include teeth or serrations on an edge and/or lower surface door 592 (see FIG. 22A). Tear initiating protrusion 596 may allow plastic film 570 to be ruptured more easily, i.e., with less force. Further, tear initiating protrusion 596 may be especially useful to facilitate puncturing plastic film 570 when plastic film 570 is relatively thick. Accordingly, when a cartridge opener (e.g., cartridge opener 650) applies a force to door 592, door 592 in turn applies a force to plastic film 570 and tear initiating protrusion 596 of door 592 may rupture plastic film 570. As door 592 continues to rotate, door 592 applies a force to body 560 of second container 530 so as to disengage body 560 from neck 529 of first container 520, causing body 560 to be pushed into an interior volume 527 of first container 520. With plastic film 570 torn, and body 560 disengaged from first container 520, first and second beverage ingredients may escape cartridge 500 through opening 583 of skirt 580. In second position, door 592 may further help to prevent body 560 from escaping cartridge 500 via upper opening 583 of skirt 580 through which beverage ingredients escape cartridge 500.

In some embodiments, beverage-ingredient cartridge 500 further includes a label 597 (see FIG. 21). Label 597 may have a generally circular shape. Label 597 may be affixed to door 592 of skirt 580. Further, label 597 may cover a line of connection at a perimeter of door 592 where door 592 meets skirt 580. Thus, label 597 may be sized and shaped similarly to door 592 of skirt 580 or may be slightly larger than door 592 of skirt 580.

Label 597 may include printed information about cartridge 500 on an upper surface. Label 597 may indicate, for example, information about the type and flavor of the beverage ingredients stored within cartridge 500. Label 597 may be affixed to door 592 of skirt 580 via adhesives or glue on a lower surface of label 597.

In some embodiments, label 597 may further include a tab 599 at a perimeter of label 597. Tab 599 may extend outwardly from the perimeter of label 597 so as to be easily grasped by a hand of a user in order to remove label 597 so that cartridge 500 may be used to dispense beverage ingredients. In some embodiments, to facilitate grasping of tab 599, tab 599 is not affixed directly to door 592 or to skirt 580 and does not include adhesives or glue thereon.

It is to be appreciated that the Detailed Description section, and not the Summary and Abstract sections, is intended to be used to interpret the claims. The Summary and Abstract sections may set forth one or more but not all exemplary embodiments of the present invention(s) as contemplated by the inventors, and thus, are not intended to limit the present invention(s) and the appended claims in any way.

The present invention(s) have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention(s) that others can, by applying knowledge within the skill of the art, readily modify and/or adapt for various applications such specific embodiments, without undue experimentation, and without departing from the general concept of the present invention(s). Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance herein.

The breadth and scope of the present invention(s) should not be limited by any of the above-described exemplary embodiments, but should be defined only in accordance with the claims and their equivalents.

What is claimed is:

1. A beverage-ingredient cartridge, comprising:
a first container comprising a neck defining an opening at an upper end of the first container;
a second container comprising:
a body removably secured within the neck of the first container by an interference fit so as to cover and seal the opening;
a lid removably secured within the neck of the first container, wherein the lid is positioned above and is in contact with the body such that the body and the lid define an interior volume of the second container; and
a skirt secured to the first container, wherein the skirt extends around the neck of the first container and defines an opening through which the second container is accessible.

2. The beverage-ingredient cartridge of claim 1, wherein the opening of the skirt has a diameter that is less than a maximum diameter of each of the body and the lid of the second container such that the body and the lid are unable to pass through the opening of the skirt.

3. The beverage-ingredient cartridge of claim 1, wherein the skirt further comprises a ridge on an interior surface of the skirt, wherein the ridge is configured to engage a lip extending outwardly from the neck of the first container to secure the skirt to the first container.

4. The beverage-ingredient cartridge of claim 3, wherein the ridge of the skirt is permanently secured to the lip of the neck of the first container.

5. The beverage-ingredient cartridge of claim 1, wherein the beverage-ingredient cartridge is made entirely of recyclable plastic.

6. The beverage-ingredient cartridge of claim 5, wherein the beverage-ingredient cartridge comprises of one or more of polypropylene (PP), polyethylene terephthalate (PET), and high density polyethylene (HDPE).

7. The beverage-ingredient cartridge of claim 1, wherein the body and the lid of the second container are configured to be disengaged from the neck of the first container in response to a force applied to the lid of the second container in a direction towards an interior volume of the cartridge,
wherein in response to the application of the force on the lid, the lid in turn exerts a force on the body of the second container such that the body and lid are disengaged from the neck of the first container.

8. The beverage-ingredient cartridge of claim 1, wherein the body of the second container comprises a base having a perimeter with a flange extending perpendicularly from the perimeter of the base.

9. The beverage-ingredient cartridge of claim 8, wherein the lid of the second container comprises a base having a perimeter with a flange extending perpendicularly from the perimeter of the base, and wherein the flange of the body of the second container meets in an end-to-end manner with the flange of the lid of the second container.

10. The beverage-ingredient cartridge of claim 1, wherein the body of the second container comprises a lip extending from a base of the body, wherein the lip is configured to prevent the body from passing through the opening of the first container to an exterior of the beverage-ingredient cartridge.

11. The beverage-ingredient cartridge of claim 1, wherein a height of the second container as measured in a direction of a longitudinal axis of the cartridge is the same as or less than a height of the neck of the first container as measured in the direction of the longitudinal axis of the cartridge.

12. The beverage-ingredient cartridge of claim 1, wherein the neck of the first container tapers from an upper end of first container toward a shoulder of the first container.

13. A system for making a beverage, comprising:
the beverage-ingredient cartridge of claim 1, further comprising:
a liquid beverage ingredient disposed within the first container, and
a dry beverage ingredient disposed within the second container; and
a beverage vessel having a cartridge opener and containing a liquid,
wherein when the beverage-ingredient cartridge is engaged with the cartridge opener of the beverage vessel, the cartridge opener pushes the second container into the first container and thereby releases the liquid and dry beverage ingredients from the beverage-ingredient cartridge into the liquid under a force of gravity.

14. A method of dispensing a beverage from a beverage-ingredient cartridge, the method comprising:
applying a force to a beverage-ingredient cartridge, wherein the beverage-ingredient cartridge comprises:
a first container having a neck at an upper end defining an opening, wherein the first container stores a first beverage ingredient,
a second container that stores a second beverage ingredient, that is secured within the neck of the first container, and that covers and seals the opening of the first container, wherein the second container comprises a body removably secured to the neck of the first container within the opening, and a lid;
disengaging the lid and the body of the second container from the neck of the first container by the force, such that the body and the lid are directed into an interior volume of the first container; and
dispensing the first and second beverage ingredients from the beverage-ingredient cartridge.

15. The method of claim 14, further comprising inverting the beverage-ingredient cartridge prior to applying the force to the second container, such that dispensing the first and second beverage ingredients occurs under a force of gravity.

16. The method of claim 14, wherein applying the force to the second container is performed by a cartridge opener applied along a longitudinal axis of the beverage-ingredient cartridge.

17. A beverage-ingredient cartridge, comprising:
a first container defining an opening at an upper end of the first container;
a second container removably secured to the upper end of the first container so as to cover and seal the opening of the first container; and
a skirt secured to the first container such that the skirt covers the second container, wherein the skirt defines an opening through which the second container is accessible.

18. The beverage-ingredient cartridge of claim 17, wherein the beverage-ingredient cartridge comprises one or more recyclable plastic materials selected from the group of polypropylene (PP), polyethylene terephthalate (PET), and high density polyethylene (HDPE).

19. The beverage-ingredient cartridge of claim 17, wherein the second container is configured to be disengaged from the first container when a force is applied to the second container in a direction towards an interior volume of the cartridge, wherein when the second container is disengaged from the body, an interior volume of the first container and the second container are open to an exterior of the beverage-ingredient cartridge.

20. The beverage-ingredient cartridge of claim 17, wherein the second container comprises a body defining an upper opening and a lower opening, a first lid removably secured to the body so as to cover the lower opening, and a second lid removably secured to the body so as to cover the upper opening.

21. A beverage-ingredient cartridge, comprising:
a first container comprising a neck defining an opening at an upper end of the first container;
a second container comprising:
a body removably secured within the neck of the first container by an interference fit so as to cover and seal the opening;
a plastic film secured to an upper end of the body such that the body and the plastic film define an interior volume of the second container; and
a skirt secured to the first container, wherein the skirt extends around the neck of the first container and defines an opening through which the second container is accessible.

22. The beverage-ingredient cartridge of claim 21, wherein the body of the second container comprises a base having a flange extending from a perimeter of the base, such that body has a cup-shape.

23. The beverage-ingredient cartridge of claim 21, wherein the skirt further comprises a door that is movable between a first position in which the door covers the opening of the skirt, and a second position in which the door is rotated toward an interior volume of the cartridge, such that as the door moves from the first position to the second position, the door punctures the plastic film and applies a force to the body such that the body is dislodged from the neck of the first container.

24. The beverage-ingredient cartridge of claim 21, wherein the plastic film is secured to the upper end of the first container.

25. The beverage-ingredient cartridge of claim 21, wherein the beverage-ingredient cartridge is made entirely of recyclable plastic.
